(19) United States
(12) Patent Application Publication
(10) Pub. No.: US 2005/0153022 A1
(43) Pub. Date: Jul. 14, 2005

(54) Process and device for deep-frying material to be deep-fried

(76) Inventors: Eberhard Schilling, Neuburg (DE); Stefan Muller, Neuburg (DE)

Correspondence Address: McGLEW AND TUTTLE, P.C.;Counselors at Law, SCARBOROUGH STATION, SCARBOROUGH, NY, 10510-0827, US

(21) Appl. No.: 11/031,787

(22) Filed: Jan. 7, 2005

(30) Foreign Application Priority Data
Jan. 10, 2004 (DE) 10 2004 001 525.2

(51) Int. Cl. A23L 1/31

(52) U.S. Cl. 426/92

(57) ABSTRACT

A process for deep-frying material to be deep-fried in a heat transfer fluid, especially fat, includes cooking the material to be deep-fried at consecutively decreasing temperature of the heat transfer fluid. A device suitable for carrying out the process is provided in which the heat transfer fluid is recycled by means of a pump and is brought into contact with the material to be deep-fried in a deep-frying container, has a series of deep-frying chambers for cooking the material to be deep-fried with different temperatures of the heat transfer fluid. The process and device make possible an especially gentle cooking operation; in particular, the formation of acrylamide, which is hazardous to health, is reduced to a minimum.

### CROSS REFERENCE TO RELATED APPLICATIONS

This application claims the benefit of priority under 35 U.S.C. § 119 of German Application DE 10 2004 001 525.2 filed Jan. 10, 2004, the entire contents of which are incorporated herein by reference.

### FIELD OF THE INVENTION

The present invention pertains to a process for deep-flying material to be deep-fried in a heat transfer fluid, especially fat. Furthermore, the present invention pertains to a device for deep-frying material to be deep-fried in a heat transfer fluid, especially fat, which can be heated by means of a heating means, is recycled by means of a pump, and is brought into contact with the material to be deep-fried in a deep-flying container.

### BACKGROUND OF THE INVENTION

Cooking foods to make the raw products contained in them fit for consumption and/or more tasty belongs to the cultural techniques acquired by mankind a long time ago. Besides hygienic and organoleptic reasons, nutrition physiological aspects, such as the denaturing of protein or the swelling of starch, play a role as well. Baking or deep-frying with fat in a pan or deep fryer improves the taste of foods. In addition, both cooking methods enjoy particular popularity because of their rapidity.

The deep-frying process is currently carried out, as a rule, with the use of conventional dipping type deep fryers, in which case a small quantity of material to be deep-fried is immersed into a relatively large quantity of deep-frying fat and is thus deep-fried. The quantity ratios are due, on the one hand, to the circumstance that a lowering of the temperature of the fat during the introduction of the material to be deep-fried shall be prevented from occurring as much as possible for rapid and uniform cooking, and, on the other hand, it shall be possible to carry out a continuous deep-frying process. As an improvement, continuously operating deep fryers are known, for example, from WO 01/21051 A1. In such deep fryers, deep-frying fat is heated in a fat reservoir, and a quantity of deep-frying fat, which is small compared to the quantity of the material to be deep-fried, is subsequently introduced into a deep-frying container. The deep-frying fat introduced is heated further extremely rapidly but in such a way that its quality is prevented from deteriorating in a separate heating zone with a large contact surface, and is returned into the reservoir via an overflow after the end of the deep-frying operation. Deep-frying fat is absorbed by the material to be deep-fried during the deep-frying operation, so that the loss must be compensated by adding fresh deep-frying fat as needed.

A large number of scientific studies have recently demonstrated that acrylamide, which is currently classified as hazardous to health for the human body because this substance is considered to be a possible carcinogen, is formed during any kind of deep-frying process. It was, furthermore, shown that the formation of acrylamide is affected mainly by the material composition of the material to be deep-fried, the deep-frying temperature during the deep-frying process, the deep-frying time as well as the quality of the deep-frying fat. In addition, it is considered to be a scientifically proven fact that the formation of acrylamide during deep-flying can be reduced by lowering the deep-frying temperature, selecting the shortest possible deep-frying time and by modifying the composition of the deep-frying fats used.

The above-mentioned factors can be affected only to an insufficient extent at best in the prior-art deep-frying processes and devices, so that such processes are associated with an increased risk for damage to health due to acrylamide during the consumption of foods prepared in this manner.

### SUMMARY OF THE INVENTION

The basic object of the present invention is to improve a process and a device of the type described in the introduction such that the acrylamide content in the deep-fried product can be kept as low as possible.

The object is accomplished in a process of the type described in the introduction by the material to be deep-fried being cooked at successively decreasing temperature of the heat transfer fluid.

To accomplish the object, provisions are made in a device of the type described in the introduction that a series of deep-frying chambers with different temperatures of the heat transfer fluid is provided for cooking the material to be deep-fried.

The deep-frying temperatures and residence times of the material to be deep-fried in the heat transfer fluid, especially fat, can thus be controlled according to the present invention in a simple, flexible and reliable manner, so that a considerable reduction of the acrylamide content in the cooked food can be achieved.

According to a preferred variant of the process according to the present invention, provisions are made for the temperature to be ≧170° C. and preferably 185° C. at the beginning of the cooking operation. Improved crust formation of pores is obtained on the surface of the material to be deep-fried due to an increased temperature at the beginning of the deep-frying operation, which leads to reduced evaporation of the moisture contained in the material to be deep-fried. This is especially advantageous concerning the formation of acrylamide, because scientific studies prove that an increased moisture content in the food is associated with an improved tendency towards the formation of acrylamide.

In addition, provisions are made in a variant of the process according to the present invention for the temperature to be <170° C. at the end of the cooking operation. According to scientific studies, a temperature of 170° C. can be considered to be a critical temperature concerning the formation of acrylamide, especially during the preparation of potatoes by deep-frying (French fries). Cooking at temperatures below this critical temperature of 170° C. ensures a further reduction of the acrylamide content.

Provisions may, furthermore, be made according to the present invention for the material to be deep-fried to pass consecutively through a number of deep-frying chambers, beginning from the first deep-frying chamber, in which chambers the heat transfer fluid has a reduced temperature compared to the particular preceding deep-frying chamber. A deep-frying temperature decreasing over time can thus be obtained in a simple manner.

The heat transfer fluid is advantageously recycled according to the present invention by a pumping means, and it is preferably heated by a heating means and subsequently fed into a first deep-frying chamber. In a preferred variant of the process according to the present invention, the heat transfer fluid is heated as a function of parameters of the material to be deep-fried present in the deep-frying chambers, especially the weight and/or the moisture content of the material to be deep-fried in the first deep-frying chamber. The temperature of the heat transfer fluid decreases when the material to be deep-fried is introduced into it mainly because of the weight and the moisture content (percentage of water) in the material to be deep-fried, because a certain quantity of heat is needed to heat the material to be deep-fried and especially to evaporate moisture (water) present in the material to be deep-fried. To make it possible to cook the material to be deep-fried in such a way that the cooking is essentially harmless for health, provisions are consequently made in the course of a preferred improvement of the process according to the present invention for the heating of the heat transfer fluid to take place such that the temperature of the heat transfer fluid is essentially 170° C. or lower in the deep-frying chambers following the first deep-frying chamber.

Since, as was already mentioned, the quality of the heat transfer fluid is also decisive for the formation or the lack of formation of acrylamide during the deep-frying process, provisions may, furthermore, be made according to the present invention for the heat transfer fluid to be filtered after it has flown through the deep-frying chambers. Furthermore, quality features of the heat transfer fluid, such as the radiation absorption behavior, viscosity and the like, may also be subjected to continuous monitoring by means of sensors, in which case the process according to the present invention is continued, the heat transfer fluid is fully or partially replaced, additives are added to the heat transfer fluid, or the process is interrupted, preferably as a function of the measured values supplied by the sensors. It can thus be ensured that the cooking operation is not carried out or continued at any time with heat transfer fluid of an inferior quality, so that the formation of acrylamide can be effectively reduced in this way as well.

In an improvement of the device according to the present invention, provisions are made for the deep-frying chambers to be arranged in a series one after another, so that the material to be deep-fried can be transferred from a deep-frying chamber into an adjacent deep-frying chamber in which the temperature of the heat transfer fluid is lower. The cooking proposed in the course of a process according to the present invention at consecutively decreasing temperatures can thus be carried out technically with a simple design.

The deep-frying chambers are expediently formed by receiving means for the material to be deep-fried. The receiving means may have a basket-like design and preferably have at least one wall that is essentially impermeable for the flow of the heat transfer fluid. Provisions may also be made in addition or as an alternative for the wall that is essentially impermeable to the flow of the heat transfer fluid to be arranged in the deep-frying container. The flow of the heat transfer fluid can be affected by means of the impermeable walls and/or partitions such that the material to be deep-fried is brought optimally into contact with the heat transfer fluid in each deep-frying chamber and the heat transfer fluid preferably flows through it in order to achieve an acceleration of the cooking process and, associated with this, a reduction in the formation of acrylamide.

Provisions are made in an extremely preferred variant of the device according to the present invention for the receiving means to be mounted tiltably for transferring the material to be deep-fried, in which case especially a rotatable mounting around an axis is provided for the tilting. The material to be deep-fried is correspondingly transferred from one deep-frying chamber into the next one in a simple manner by tilting the receiving means, which may be performed manually or automatically.

The deep-frying container of a device according to the present invention may have an inlet [for the heat transfer fluid] in the area of the first deep-frying chamber and an outlet for the heat transfer fluid in the area of the last deep-frying chamber. In addition, a temperature sensor may be provided at least in the inlet area of the deep-frying container, so that the inlet temperature of the heat transfer fluid can be regulated as a function of at least one measured signal of the temperature sensor. It is ensured in this manner that the temperature profile of about 185° C. decreasing to a value of ≦170° C., as was outlined above, can be obtained in the deep-frying container, i.e., in the individual deep-frying chambers, at any time.

In a variant, the device according to the present invention may have an additional heating means for the fine regulation of the inlet temperature. As an alternative or in addition, the same purpose is served by a mixing device for mixing quantities of the heat transfer fluid with different temperatures before the heat transfer fluid flows into the deep-frying container.

To make it possible to completely remove the heat transfer fluid from the deep-frying container, for example, for cleaning purposes, a device according to the present invention has, according to another embodiment, a reservoir for the heat transfer fluid from the deep-frying container. To determine quality features of the heat transfer fluid, such as the radiation absorption behavior, viscosity or the like, a sensor means may be arranged in the reservoir. Furthermore, a device according to the present invention preferably has a filter means for the heat transfer fluid to preserve the quality of the heat transfer fluid by removing suspended matter. Feed means for replacement heat transfer fluid and/or additives, which have a container for the medium to be fed as well as a pumping means in the preferred embodiment, may also be present for the same reason.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

Other properties and advantages of the present invention will appear from the following description of exemplary embodiments on the basis of the drawings. In the drawings,

FIG. 1 is a schematic view of a first embodiment of the device according to the present invention;

FIG. 2 is a temperature profile of the heat transfer fluid in a device according to the present invention;

FIG. 3 is a schematic view of another embodiment of the device according to the present invention; and

FIG. 4 is a schematic view of a third embodiment of the device according to the present invention.

### DESCRIPTION OF THE PREFERRED EMBODIMENTS

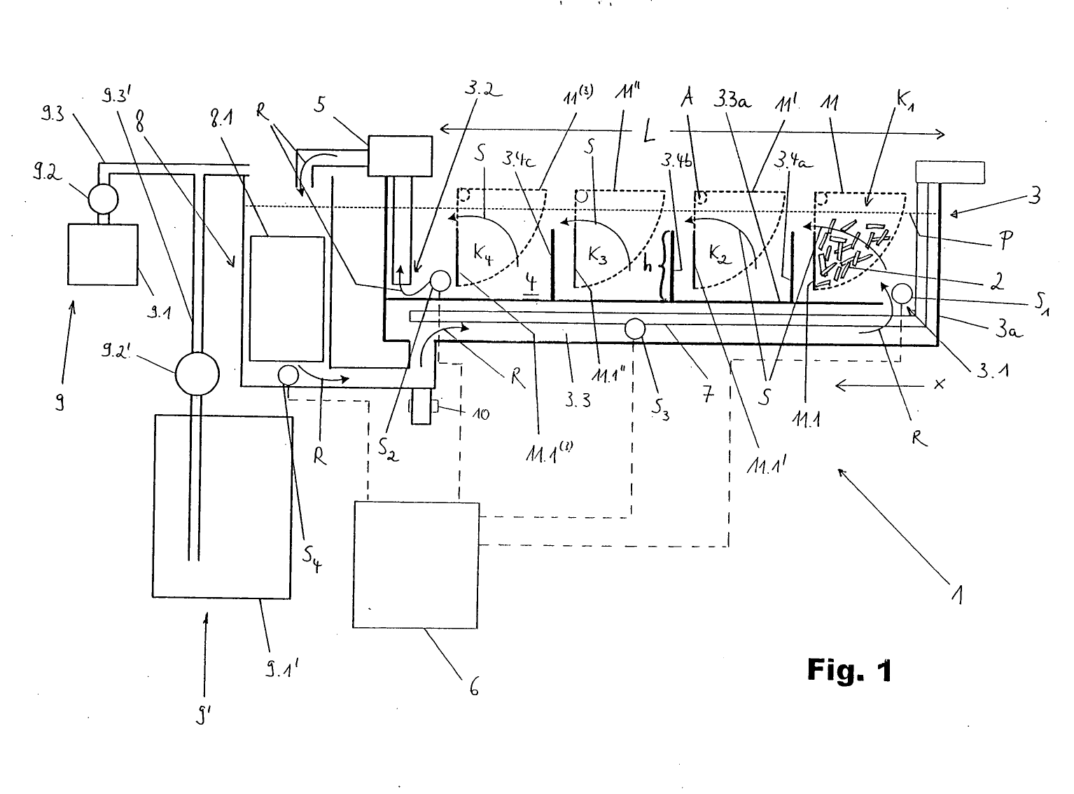

Referring to the drawings in particular, FIG. 1 shows a schematic view of a first embodiment of the device 1 according to the present invention for deep-frying material to be deep-fried 2, for example, French fries, which are shown only by way of example in FIG. 1 for reasons of clarity.

The device 1 according to the present invention has, first, a deep-frying container 3, which is filled with a heat transfer fluid 4, here deep-frying fat, for cooking the material to be deep-fried 2. The filling level of the deep-frying container 3 is marked by a broken (level) line P. The deep-frying container 3 has an inlet 3.1 and an outlet 3.2 for the heat transfer fluid 4, which is circulated (arrow R) through the deep-frying container 3 by means of an oil pump 5 in the area of the outlet 3.2. Temperature sensors S₁, S₂ for determining the temperature θ_{I}, θ_{O} of the heat transfer fluid 4, which are connected with a control means 6 of the device 1 via lines indicated by broken lines, are arranged in the inlet area 3.1 and in the outlet area 3.2 of the deep-frying container 3.

A heating chamber 3.3, through which the heat transfer fluid 4 can likewise flow and which is separated from the deep-frying container proper by a bulkhead partition 3.3a, is located upstream of the inlet 3.1 of the deep-frying container 3, and a heating means 7 for the heat transfer fluid 4, here a tubular heating element, which may have a series of PCT resistor heating elements (not shown), for example, within a jacket tube, is arranged in the heating chamber 3.3. Furthermore, an additional temperature sensor S₃ for determining the temperature of the heat transfer fluid 4, which said sensor is likewise in functional connection with the control means 6 (broken line), is arranged in the heating chamber 3.3.

Moreover, according to FIG. 1, the device 1 according to the present invention has, outside the deep-frying container 3, a filter means 8 for the heat transfer fluid, which contains a filter element 8.1 for the heat transfer fluid as well as a sensor S₄ for monitoring quality parameters of the heat transfer fluid 4, such as the relative permittivity, the radiation absorption behavior (turbidity), viscosity or the like. In conjunction with the filter means 8, the device according to the present invention has feed means 9, 9′ for additives or replacement heat transfer fluid. These have a reservoir 9.1, 9.1′ for the additives and for the replacement fluid as well as suitable pumping means 9.2, 9.2′ for delivering the particular medium to be fed. The feeding takes place via (partially common) feed lines 9.3, 9.3′. In an area between the filter means 8 and the deep-frying container 3 or the heating chamber 3.3, the device 1 according to the present invention has a drain means 10 for the heat transfer fluid 4.

As was explicitly shown for the sensors S₁-S₄, all other components of the device according to the present invention, which can be actuated mechanically and/or electrically, i.e., the pump 5, the tubular heating element 7, the pumping means 9.2, 9.2′ as well as the drain means 10 are in connection with the control means 6 of the device 1 according to the present invention via corresponding connections, but this is not shown in FIG. 1 for reasons of clarity. The control means 6 is thus capable of ensuring the comprehensive control of the device 1 according to the present invention.

A series of deep-frying chambers K₁-K₄ are formed within the deep-frying container 3 of the device 1 according to the present invention. In general, a number n of deep-frying chambers Kₙ may be provided. A number of vertical partitions 3.4a, 3.4b, 3.4c, whose vertical extension h ends below a level P of the heat transfer fluid 4 in the deep-frying container 3, are provided within the deep-frying container 3 to create the deep-frying chambers K₁-K₄. Receiving means 11, 11′, 11″, 11⁽³⁾ in the form of deep-frying baskets are arranged in the deep-frying chambers K₁-K₄. The deep-frying baskets have a cross section of an essentially circular segment-shaped form, which corresponds especially to a square in the exemplary embodiment being shown. The deep-frying baskets 11-11⁽³⁾ are made essentially permeable to the heat transfer fluid 4, as it is suggested by the broken limiting lines of the deep-frying baskets and the arrows S, which latter indicate the direction of flow of the heat transfer fluid 4 within the deep-frying chambers K₁-K₄ and hence through the deep-frying baskets 11-11⁽³⁾ and the material to be deep-fried 2. In their lower area, which is the rear area in relation to the flow S, the receiving means 11-11⁽³⁾ have a wall 11.1, 11.1′, 11.1″, 11.1⁽³⁾, which is essentially impermeable to the heat transfer fluid 4 and ensures, together with the partitions 3.4a-c already described, a defined flow S in the deep-frying chambers K₁-K₄. It becomes clear from the graphic representation that the flow behavior S shown can also be achieved alternatively in a similar manner without the partitions 3.4a-c, so that these may be eliminated in the course of an alternative embodiment of the device 1 according to the present invention, in which case their task is assumed solely by the impermeable wall 11.1-11.1⁽³⁾ of the deep-frying baskets.

The receiving means 11-11⁽³⁾ can be pivoted or tilted in their rear, upper area about an axis A extending in parallel to the surface O of the heat transfer fluid 4 in the deep-frying container 3 essentially in the direction of the flow loop S; for reasons of clarity, the axis A is shown explicitly for the receiving means 11′ in the deep-frying chamber K₂ only, but an identical axis is also present in each of the other deep-frying chambers K₁, K₃, K₄. Any drive means as may be present (not shown) for tilting the receiving means 11-11⁽³⁾ around the axes A are likewise connected with the control means 6 of the device 1 and can thus be controlled by same.

A direction of extension of the deep-frying container 3 is designated by “x” in FIG. 1; a length of the deep-frying container 3 between the wall 3a thereof in the inlet area 3.1 and a position of the temperature sensor S₂ in the outlet area 3.2 is designated by “L” in FIG. 1.

The deep-frying process according to the present invention takes place as follows with the use of the deep-frying device shown in FIG. 1: The heat transfer fluid 4 (deep-frying fat) flows past the tubular heating element 7 in the heating chamber 3.3, it is heated by said tubular heating element 7 to a temperature of >170° C., preferably about 185° C., and it subsequently flows past the temperature sensor S₁ through the inlet 3.1 into the first deep-frying chamber K₁, which contains fresh material to be deep-fried 2 in the receiving means 11. The heating chamber 3.3 is used here at the same time as a (thermal) energy storage means. The hot deep-frying fat flows through the material to be deep-fried 2 in the deep-frying chamber K₁, and the cooking process begins. The necessary temperature of the deep-frying fat in the deep-frying chamber K₁ depends on the amount of energy that is needed to heat up the material to be deep-fried 2. This amount of heat depends on the quantity of material to be deep-fried introduced as well as other parameters of the material to be deep-fried 2, such as the water content thereof. The optimal temperature is to be determined experimentally. The increased temperature of the fat in the first deep-frying chamber K₁ is used, besides for the rapid heating of the material to be deep-fried 2, especially for the efficient closing of pores on the surface of the material to be deep-fried due to crust formation, as a result of which the loss of moisture from the material to be deep-fried 2, which is favorable for the formation of acrylamide, is at least partially prevented from occurring.

The temperature of the deep-frying fat decreases continuously in the direction of extension x of the deep-frying container 3 from one chamber to the next because of heat losses to the material to be deep-fried 2 and the environment (due to radiation, convection and heat conduction), i.e., the temperature of the deep-frying fat is higher in chamber K₂ than the temperature of the deep-frying fat in the deep-frying chamber K₃, which in turn is higher than the temperature in the deep-frying chamber K₄ (Kₙ), which is <170° C. according to the present invention. By pivoting the deep-frying baskets 11-11⁽³⁾ around their respective axis A—either manually or in an automated manner via drive means and control—and by tilting the material to be deep-fried 2 farther into the respective subsequent receiving means 11′-11⁽³⁾, which is brought about as a result, the cooking process is thus continued according to the present invention with consecutively decreasing deep-frying temperature. This is detected continuously by means of the temperature sensors S₁-S₃ and adjusted by controlling the heating output of the tubular heating element 7 such that the increased inlet temperature will prevail within the first deep-frying chamber K₁ and a final temperature of <170° C. will prevail in the last deep-frying chamber K₄ (Kₙ). The energy supply is correspondingly regulated by heating as a function of the temperature gradient of the deep-frying fat in the deep-frying container 3 and the quantity of material to be deep-fried 2 introduced. In addition, the energy supply can also be additionally affected by a suitable regulation of the velocity of flow of the heat transfer fluid 4 by correspondingly actuating the pump 5.

The transfer of the material to be deep-fried from one chamber to the next by tilting the baskets is also advantageous especially in case of relatively soft material to be deep-fried because the material to be deep-fried will thus not stick. By contrast, continuous delivery, which is not shown here explicitly, is also possible in case of relatively solid materials to be deep-fried.

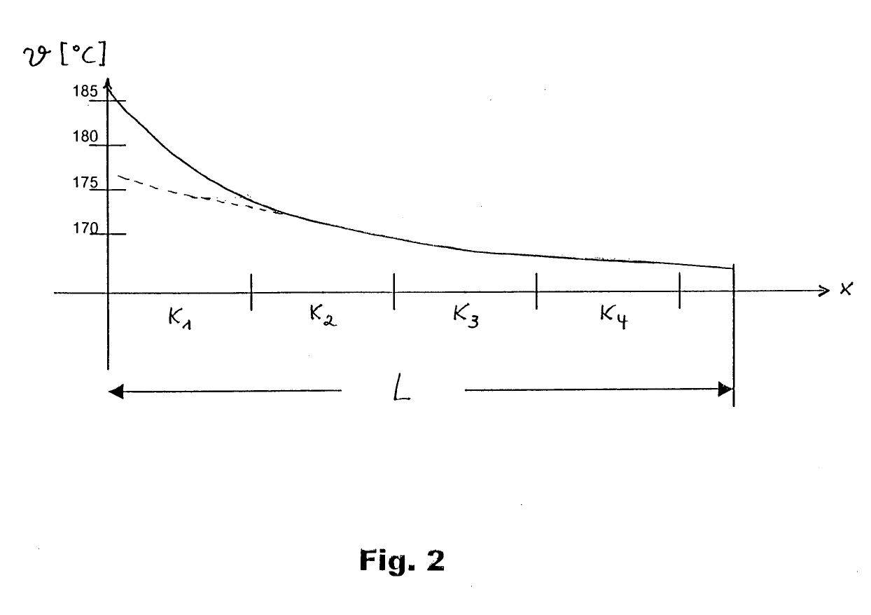

The temperature profile in the deep-frying container 3, which was characterized above, is shown in FIG. 2 in a simplified form. For the graphic representation in FIG. 2, the temperature θ in ° C. was plotted over the longitudinal coordinate x for the extension of the deep-frying container 3; furthermore, the areas of the deep-frying chambers K₁-K₄ are marked along the x axis. The starting point of the temperature curve shown in FIG. 2 coincides with the location of the inlet temperature sensor S₁, and its end point coincides with the location of the outlet temperature sensor S₂. It can be determined from the graphic representation that the temperature θ of the deep-frying fat in the first deep-frying chamber K₁ decreases greatly due to the introduction of fresh material to be deep-fried and it subsequently decreases further, but it does so more slowly, toward higher x values, in the chambers K₂-K₄, until a temperature of θ<170° C. is reached in the last deep-frying chamber K₄.

The great reduction of the deep-frying temperature in chamber K₁ is explained above all by the loss of moisture from the material to be deep-fried due to the evaporation of water during heating. This fact shall be illustrated below by a calculation example:
Weight of material to be deep-fried: m_{F}=160 g
weight of water: m_{W}=100 g
weight of rest: m_{R}=60 g (carbohydrates, protein)
specific heat capacity of water: c_{W}=4.2 J/(g·K)
specific heat capacity of rest: c_{R}=1.5 J[/](g·K)
specific energy of evaporation of water: eᵥ=2,260 J/g
initial temperature of material to be deep-fried: Oᵢₙᵢₜ=30° C.
final temperature of deep-fried material: θ_{end}=90° C.
   The thermal energy E needed for a temperature change of a body having the weight m and the specific heat capacity c by a temperature difference Δθ can be calculated according to the general formula:
   E=c·m·Δθ,
   so that if it is assumed that 50% of the water contained in the material to be deep-fried, corresponding to a weight of m_{W}′=50 g, will evaporate during the deep-frying, the amount of energy to be supplied is calculated as
   E=c_{W}·(m_{F}−m_{W}′)·(θᵢₙᵢₜ−↓_{end})+c_{W}·m_{W}′·(100° C.−θᵢₙᵢₜ)+c_{R}·m_{F1}·(θ_{end}−θᵢₙᵢₜ)+eᵥ·m_{W}′.

After inserting the numerical values indicated, an energy demand of E=145.7 kJ is obtained, of which 113 kJ account for the energy of evaporation Eᵥ=m_{W}′·eᵥ alone, so that the energy demand is determined especially by the evaporation of the water contained in the material to be deep-fried.

The energy E calculated above is extracted from the heat transfer fluid in the process according to the present invention and in the device according to the present invention, which leads to a reduction of the temperature of the heat transfer fluid depending on the weight of the heat transfer fluid. With c_{F1}=1.67 J/(g·K) for the specific heat capacity of the fluid and according to what was stated above,
Δθ=E/(c_{F1}·m_{F1}),
so that a 1/m_{F1} dependence of the temperature reduction Δθ on the weight of the fluid present is obtained. The reduction Δθ of the temperature of the deep-frying fat delays the cooking process and leads to the increased formation of acrylamide, and the energy E removed is therefore steadily compensated by the heat supply regulated according to the present invention. According to the view in FIG. 2, a temperature reduction of Δθ=18° C. takes place in the deep-frying chamber K₁. According to what was stated above, this leads to a value of m_{F1}=4.9 kg at an energy demand of E=146 kJ. This means that by introducing m_{F}=160 g of material to be deep-fried, the temperature of about 4.9 kg of deep-frying fat will decrease by 18° C. according to the assumptions made above. The cooling does not take place linearly over time and must be compensated by the inflow of a suitably heated deep-frying fat if it is desirable to keep the weight of the fluid lower. This is achieved according to the present invention by adjusting the heating output of the tubular heating element 7 and/or the pumping capacity of the pump 5 by the control means 6 according to the temperature information provided by the temperature sensors S₁-S₄.

As a general rule, the amount of energy must be supplied within a defined period of time as a function of the energy demand in order to optimize the cooking process.

If, as in the above calculation example, 146 kJ are needed to evaporate the moisture contained in 160 g of material to be deep-fried, it may, furthermore, be assumed that up to 75% of the water will have already evaporated after 30-50 sec, depending on the nature of the material to be deep-fried, and 75% of the rest of the energy demand (110 kJ) is also needed.

The following equation is obtained at a hypothetical temperature difference of Δθ=185° C.−170° C.=15° C. (corresponding to 15 K):

$${m}_{Fl} = \frac{E}{{c}_{Fl} \cdot Δθ} = \frac{110 kJ}{1.67 J \text{/} g \cdot 15 K} = 4.4 kg .$$

It follows from this that at least 4.4 kg of deep-frying fat with 185° C. must be fed in in 30 sec in order to prevent the deep-frying temperature from dropping, on average, below 170° C.

The necessary energy of 146 kJ is available over the entire cooking time at a temperature difference of Δθ=15° C. in a deep-frying amount of deep-frying fat of about 6 kg. Consequently, about 6 kg of deep-frying fat with 185° C. are added within 30 sec in case of continuous production to guarantee the deep-frying temperature of 170° C. at the end of the process. The hypothetical cooking time is about 120 sec; if a plurality of portions are being cooked simultaneously, the energy demand per unit of time increases correspondingly. A change in the parameter Δθ affects the necessary deep-frying amount of deep-frying fat per time.

In general, it can be stated that the amount of energy needed for deep-frying per g of material to be deep-fried is about 0.9 kJ, which corresponds to about 0.036 kg of deep-frying oil with Δθ=15° C. in case of a material to be deep-fried, containing
33% of carbohydrates/protein and
66% of water, including
50% water that will be evaporated.
   To prevent the cooking temperature from decreasing in the process, this energy is supplied within the framework of the present invention as a function of the instantaneous demand within the specified cooking time.

The deep-frying temperature in chamber K₁ decreases in the manner outlined in FIG. 2 only if fresh material to be deep-fried 2 is present in the deep-frying chamber K₁. If this is not the case, correspondingly cooler heat transfer fluid 4 is introduced into the chamber K₁ (broken line in FIG. 2) due to the control according to the present invention, so that the desired temperature curve θ(x) shown will continue to prevail in the subsequent chambers K₂-K₄. The inlet temperature θ₁ at which the deep-frying fat is introduced into the deep-frying chamber K₁ can be reduced even further according to the present invention if the next deep-frying chambers K₂-K₄ will also consecutively fail to contain any material to be deep-fried 2 any longer, for example, due to further tilting into the particular next receiving means 11″, 11⁽³⁾ and removal at the end of the deep-frying container 3.

To evaluate the quality of the deep-frying fat, parameters of the deep-frying fat, which are determined by means of the sensor S₄ shown in FIG. 1, are measured. These parameters may be the heat capacity C_{F1} of the deep-frying fat, which was already mentioned above, or other physical parameters, such as the relative permittivity ε, a degree of radiation absorption as an indicator of the turbidity of the deep-frying fat and/or the viscosity thereof. The sensor S₄ is preferably not designed for the measurement of absolute values, but it measures only relative values and must therefore always be calibrated with fresh deep-frying fat to be used (set point). The deviation of the continuously measured actual value from the set point affects the control process according to the present invention, which comprises
a) the continuation of the deep-frying process according to the present invention;
b) the addition of a certain quantity of free deep-frying fat;
c) the addition of additives; or
d) the interruption of the deep-frying operation.

The necessary data are sent by the sensor S₄ and transmitted to the control means 6 of the device 1. Via control connections, not shown, the device can subsequently actuate either the pumping means 9.2, 9.2′ for feeding additives or fresh fat, or initiate the complete replacement of the heat transfer fluid 4 by actuating the drain means 10. To interrupt the deep-frying operation, the circulating pump 5 can be stopped and the tubular heating element 7 can be switched off by means of suitable control signals of the control means 6.

In functional connection with the axes A of the receiving means 11-11⁽³⁾, the device according to the present invention may have, as was said, suitable drive means, not shown, for the automatic tilting of the receiving means, which can preferably also be actuated via the control means 6 according to a predetermined flow chart, so that the deep-frying operation according to the present invention can take place possibly independently from a human operator operating the device. The suitable additives include, in principle, all the additives known to the person skilled in the art especially for improving the heat transfer to the material to be deep-fried or as stabilizers, for example, citric acid, ascorbic acid, curcuma oil, rosemary oil and emulsifying agents. However, the use of silicone (E900) is preferably deliberately avoided in light of the acrylamide problem mentioned.

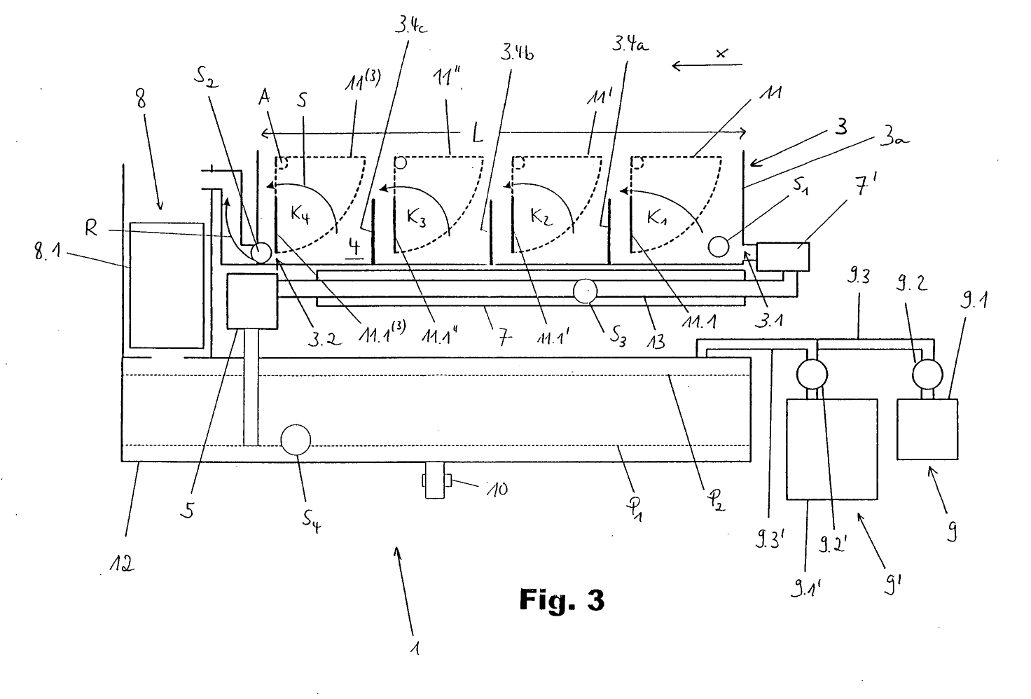

FIG. 3 shows another embodiment of the deep-frying device 1 according to the present invention, which essentially corresponds, especially in the basic features of the inventive concept, to the deep-frying device shown in FIG. 1 and already described in detail on the basis of that figure. Identical components of the deep-frying device are consequently designated by the same reference numbers as in FIG. 1. Therefore, only the essential differences from the embodiment shown in FIG. 1 shall be discussed here.

Instead of the heating chamber 3.3 (FIG. 1) made in one piece with the deep-frying container 3, a separate tank 12, which joins the filter means 8 in the direction of the fluid flow R, is provided for the heat transfer fluid 4 in the subject of FIG. 3. The tank 12 is in connection with the feed means 9, 9′ for additives and replacement fluid. The heat transfer fluid 4 is delivered from the tank 12 by means of the pump 5 into the deep-frying container 3. According to the embodiment shown in FIG. 3, the tank 12 has the sensor means S₄ as well as the drain means 10. The levels of the heat transfer fluid 4 during the operation of the device 1 (P₁) and during the return P₂, i.e., when the total quantity of the heat transfer fluid 4 has been drained from the deep-frying container 3, are indicated within the tank 12 by broken lines.

The heat transfer fluid 4 is heated on its way in the direction of an inlet 3.1 of the deep-frying container 3 by means of a heating means 7 which is arranged along a fluid line 13 and optionally surrounds same. The heating means 7 is complemented by another heating means 7′ in the immediate vicinity of the inlet 3.1, which acts as a dynamic heater and thus makes possible the more accurate (fine) metering of the thermal energy being fed.

As was already indicated in FIG. 1, the delivery and heating means, in particular, are connected with a control means 6 of the device 1 according to the present invention, but it is not shown explicitly again in FIG. 3 for reasons of clarity.

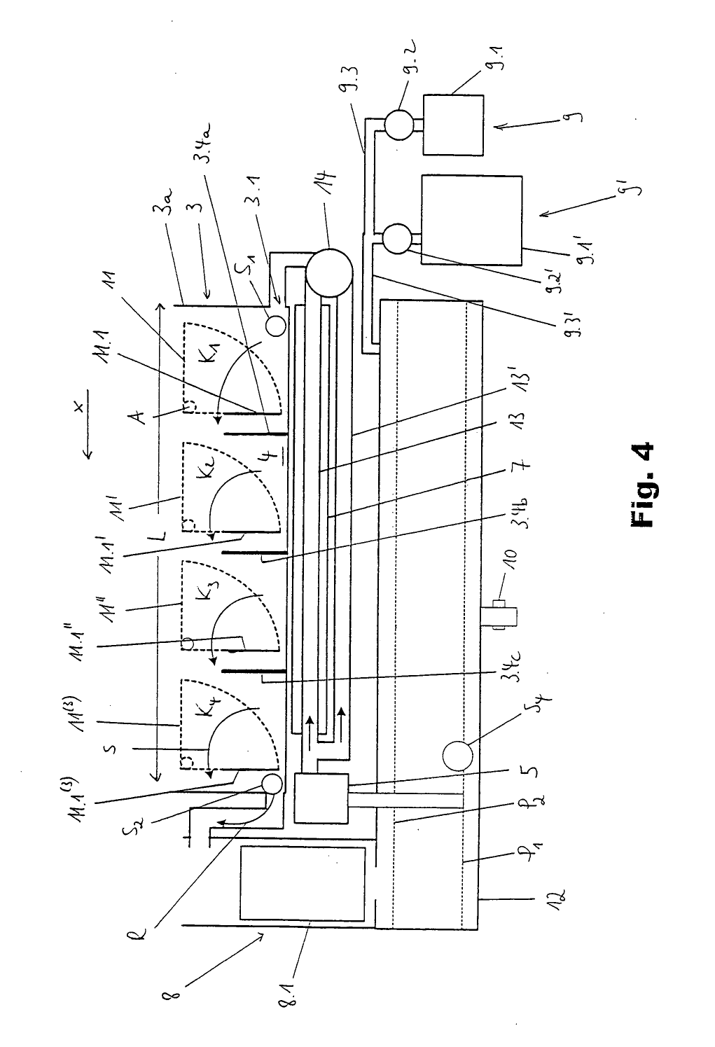

The subject of FIG. 4 shows, compared to the embodiment of the deep-frying device 1 described on the basis of FIG. 3, a mixing means 14 in the form of a three-way valve instead of the additional heating means 7′ (FIG. 3). In addition to the fluid line 13 already shown in FIG. 3 in the area of the heating means 7, a fluid line 13′, which is essentially parallel to the fluid line 13, is provided in the embodiment according to FIG. 4, but this fluid line 13′ is not in contact with the heating means 7, so that the heat transfer fluid 4 being carried in it is not heated by the heating means 7. The three-way valve 14 is designed for mixing the deep-frying fat flowing through the fluid line 13, which was heated by the heating means 7 to temperatures above 170° C., and the deep-frying fat flowing through the pipeline 13′, so that an energy supply that can be dynamically regulated can thus be achieved in the inlet area 3.1 or in the chamber K₁ of the deep-frying container 3.

As in FIG. 3, the control means 6 is not shown explicitly for reasons of clarity; it is preferably additionally designed for actuating the mixing device 14 in the embodiment according to FIG. 4 and is correspondingly connected with same.

By positioning the smallest possible quantity of material to be deep-fried (portion sizes of approx. 100-200 g; cf. the above calculation example), it is guaranteed according to the present invention that the deep-frying fat, which is caused to flow, can flow better through the material to be deep-fried than in prior-art conventional deep-frying processes, in which relatively large quantities of material to be deep-fried are deep-fried during a cooking operation. By introducing only a small quantity of material to be deep-fried of a certain temperature into heated deep-frying fat of a different, higher temperature, the cooling Δθ of the deep-frying fat decreases because of the relationships explained in detail above, which are also described by a formula. Together with the elevated inlet temperature θ₁ proposed for the deep-frying fat, this leads to better crust formation of the pores on the surface of the material to be deep-fried at the beginning of the deep-frying operation compared to conventional deep-frying processes. As a result, the diffusion of fat molecules into the core area of the material to be deep-fried will subsequently decrease, so that the material to be deep-fried will have, as a result, a correspondingly lower percentage of fat. What is decisive here is not the absolute weight of the material to be deep-fried but the amount of energy needed to heat the material to be deep-fried. If the material to be deep-fried has a high water content and especially a relatively large surface compared to its volume (e.g., cut material to be deep-fried), energy is removed from the deep-frying fat very rapidly, especially at the beginning of the deep-frying operation, and correspondingly smaller quantities are to be introduced. However, if the material to be deep-fried is in the form of complete pieces, e.g., chicken legs or pastry products with a relatively high percentage of water, the energy demand for heating will be distributed over a relatively long period of time and/or it is, on the whole, not so high, so that it is also possible to introduce larger quantities.

Moreover, a reduction of the overall deep-frying time is achieved due to the rapid and uniform heating of the material to be deep-fried, which is achieved according to the present invention. As a result and especially also because of the temperature profile provided according to the present invention, the formation of acrylamide, which is undesirable because it is hazardous to health, is reduced to a basically unavoidable minimum.

While specific embodiments of the invention have been shown and described in detail to illustrate the application of the principles of the invention, it will be understood that the invention may be embodied otherwise without departing from such principles.

1. A process for deep-frying material to be deep-fried in a heat transfer fluid such as fat, the process comprising: cooking the material to be deep-fried at a consecutively decreasing temperature of the heat transfer fluid.

2. A process in accordance with claim 1, wherein the temperature is >170° C. and preferably 185° C. at the beginning of the cooking operation.

3. A process in accordance with claim 1, wherein the temperature is <170° C. at the end of the cooking operation.

4. A process in accordance with claim 1, wherein starting from a first deep-frying chamber, the material to be deep-fried consecutively passes through a number of deep-frying chambers, in which the temperature of the heat transfer fluid is reduced compared to the preceding deep-frying chamber.

5. A process in accordance with claim 1, wherein the heat transfer fluid is recycled by a pumping means.

6. A process in accordance with claim 4, wherein the heat transfer fluid is heated by a heating means and is subsequently fed to the first deep-frying chamber.

7. A process in accordance with claim 6, wherein the heating of the heat transfer fluid is carried out as a function of parameters of the material to be deep-fried present in the deep-frying chambers, including the weight and/or the water content of the material to be deep-fried in the first deep-frying chamber.

8. A process in accordance with claim 6, wherein the heating of the heat transfer fluid is carried out such that the temperature of the heat transfer fluid is essentially 170° C. or lower in the deep-frying chambers following the first deep-frying chamber.

9. A process in accordance with claim 5, wherein the heat transfer fluid is filtered after flowing through the deep-frying chambers.

10. A process in accordance with claim 1, wherein quality features of the heat transfer fluid, such as the radiation absorption behavior, viscosity or the like, are continuously determined by means of sensors.

11. A process in accordance with claim 10, wherein depending on the values measured by the sensors, the process is either continued; the heat transfer fluid is fully or partially replaced; additives are added to the heat transfer fluid, or the process is interrupted.

12. A device for deep-frying material to be deep-fried in a heat transfer fluid such as fat, which is recycled by means of a pump and is brought intro contact with the material to be deep-fried in a deep-frying container, the device comprising: a series of deep-frying chambers with different temperatures of the heat transfer fluid provided for cooking the material to be deep-fried.

13. A device in accordance with claim 12, wherein the deep-frying chambers are arranged in series one after another.

14. A device in accordance with claim 12, wherein the material to be deep-fried can be transferred from a deep-frying chamber into a respective adjacent deep-frying chamber with lower temperature of the heat transfer fluid.

15. A device in accordance with claim 12, wherein the deep-frying chambers are formed by receiving means for receiving the material to be deep-fried.

16. A device in accordance with claim 15, wherein the receiving means have a basket-like design.

17. A device in accordance with claim 15, wherein the receiving means have at least one wall that is essentially impermeable to the flow of the heat transfer fluid.

18. A device in accordance with claim 15, wherein a wall that is essentially impermeable to the flow of the heat transfer fluid is arranged in the deep-frying container between the receiving means.

19. A device in accordance with claim 18, wherein the vertical extension of the wall ends below a level of the heat transfer fluid.

20. A device in accordance with claim 17, wherein the flow of the heat transfer fluid through the deep-frying container is affected in its direction by the wall.

21. A device in accordance with claim 15, wherein the receiving means are mounted tiltably for transferring the material to be deep-fried.

22. A device in accordance with claim 21, wherein the receiving means are mounted rotatably for tilting around a axis.

23. A device in accordance with claim 13, wherein the deep-frying container has an inlet in the area of the deep-frying chamber and an outlet for the heat transfer fluid in the area of the last deep-frying chamber.

24. A device in accordance with claim 12, wherein a temperature sensor is provided at least in the inlet area of the deep-frying container.

25. A device in accordance with claim 24, wherein an inlet temperature of the heat transfer fluid can be regulated as a function of a measured signal of the temperature sensor.

26. A device in accordance with claim 12, further comprising an additional heating means for the fine regulation of the inlet temperature.

27. A device in accordance with claim 12, further comprising a mixing means for mixing quantities of the heat transfer fluid with different temperatures for the fine regulation of the inlet temperature.

28. A device in accordance with claim 12, further comprising a reservoir for the heat transfer fluid from the deep-frying container.

29. A device in accordance with claim 12, further comprising a sensor means for determining quality features of the heat transfer fluid, such as radiation absorption, viscosity or the like.

30. A device in accordance with claim 29, wherein the sensor means is arranged in the reservoir.

31. A device in accordance with claim 12, further comprising a filter means for filtering the heat transfer fluid.

32. A device in accordance with claim 12, further comprising a feed means for a replacement heat transfer fluid and/or additives.

33. A device in accordance with claim 32, wherein the feed means includes a container for the medium to be fed as well as a pumping means.
